(19) United States
(12) Patent Application Publication
(10) Pub. No.: US 2024/0180054 A1
(43) Pub. Date: Jun. 6, 2024

(54) MOTOR-DRIVEN MACHINE FOR BIODIVERSITY-FRIENDLY WORKING OF THE SOIL

(71) Applicant: PUBERT HENRI SAS, CHANTONNAY (FR)

(72) Inventors: Nicolas Gerbaud, MONSIREIGNE (FR); Peter Vion, POUZAUGES (FR)

(21) Appl. No.: 18/279,693

(22) PCT Filed: Feb. 3, 2022
(86) PCT No.: PCT/EP2022/052558

§ 371 Date: Aug. 31, 2023

(30) Foreign Application Priority Data
Mar. 5, 2021 (FR) 2102153

(51) Int. Cl. A01B 1/06; A01B 33/06

(52) U.S. Cl. CPC A01B 1/065; A01B 33/06

(57) ABSTRACT

A motorized machine for ground or soil cultivation. The machine includes a grip located on the side of a first end of the machine for gripping the machine; a tool head mounted on the side of a second end of the machine opposite the first end, the tool head supporting at least two tools; a body connecting the first and second ends, a rotational element for rotating the tools in counter-rotating directions around separate parallel axes of rotation, the axes of rotation of the tools extending, in the use configuration of the machine, in parallel planes substantially perpendicular to the surface of the ground or the soil, the at least two tools each including claws having a round cross-section and a curved shape.

### TECHNICAL FIELD

The field of the invention is that of motor-driven gardening machines of the type serving to cultivate a garden, green spaces, flowerbeds or planters.

In particular, the invention relates to motor-driven machines for working the earth or soil, of the portable or walk-behind type, which are biodiversity-friendly.

### PRIOR ART

Motor-driven machines for working the soil, of the walk-behind type, have been on the market for many years.

Typically, such machines are provided with tools on opposite sides that rotate in a vertical plane, about horizontal axes, in the direction of travel of the machine. The tools turn the soil by bringing the lower layers of soil up to the surface while bringing the upper layers of soil down, and by kneading and crushing the different layers of soil together.

However, a drawback of this type of machines is that, as the lower layers containing micro-organisms rise to the surface, an imbalance in the soil can occur. Furthermore, many living organisms such as earthworms living in the soil can be cut up by the tools, which is undesirable as such living organisms are beneficial to richness and fertility of the soil.

Furthermore, in such motor-driven machines, the tools rotate at relatively high speeds, which can a risk the in represent for user, especially heterogeneous soils that include stones. Indeed, these stones can be thrown by the tools towards the operator, representing a risk in the event of impact with the same.

Depending on the soil conditions, vibration can become significant, causing drive discomfort and being detrimental to the user comfort. These difficult and punishing driving conditions mean that the machine is not adapted for the elderly or young people.

There is therefore a need to improve motor-driven machines for working the ground or soil.

### DISCLOSURE OF THE INVENTION

The invention meets this need by providing a motor-driven machine for working the ground and soil especially, said machine comprising:
means for gripping said machine located on the side of a first end of said machine;
a tool head mounted on the side of a second end of said machine, opposite to the first end, said head carrying at least two tools;
a body connecting the first and second ends,
means for rotatably driving said tools along counter-rotating directions about distinct parallel axes of rotation, the axes of rotation of the tools being configured so that, when the machine is configured for use, the tools are located substantially vertically above the ground,
said at least two tools each comprising claws with a round cross-section and curved shape. The claw design is protective towards earthworms, unlike the cutter or fingers conventionally used, which are aggressive and crush everything.

The counter-rotating tools penetrate the soil along a roughly vertical direction.

The tools, which take the form of helical or spiroidal curved wires, provide a natural forward feed effect that makes the machine easier to use. This force, which tends to make the tools penetrate the earth, makes the machine to handle and easy ergonomic (limiting musculoskeletal disorders MSD).

This motor-driven machine for working the soil can be portable. This motor-driven machine produces a reverse rotation movement of the axes of the tools in relation to each other.

Such an invention is particularly useful for working the soil, especially in planters, or for treating gardens and green spaces.

According to one particular embodiment, the tool head is hingedly mounted to the body by means of orientation means, so as to be able to orientate said tools in a plurality of earth or soil work positions, the axis of rotation of the tool head being orthogonal to each of the axes of rotation of the tools.

Thus, in this particular embodiment, the angular position of the head carrying the working tools is adjustable or adaptable. Because the tools are orientable, the angle of attack of the tools can be adjusted according to the type of soil to be worked.

In another embodiment, the angular position of the head carrying the working tools is fixed and cannot be adjusted.

According to one particular aspect of the invention, said means for rotatably driving said tools are located on the side of the tool head.

According to one particular implementation of the invention, said means for rotatably driving the tools comprise two electric motor reducers each rotatably driving one of said tools.

According to another particular implementation of the invention, the means for rotatably driving the comprise a single electric motor reducer tools rotatably driving said two tools.

According to one particular aspect of the invention, each tool comprises one or more elements for working the ground or soil integral with a first stage reversibly mounted to a second stage connected to the motor reducer.

Each tool is thus removably mounted to the tool head by means of a removable fastener.

According to one particular aspect of the invention, said tools rotate at a speed of between 25 revolutions/minute and 75 revolutions/minute, preferably 50 revolutions/minute.

The speed of rotation of the tools is relatively low, making the machine easy to handle. Furthermore, the very low rotational speed of the tool ensures that the soil is worked smoothly. Tools used in machines of prior art rotate at much higher speeds.

According to particular aspect of the one invention, the motor-driven machine is powered by a rechargeable electric battery.

According to one particular aspect of the invention, the tool head carries a safety bar movable between at least one safety position in which the rotary drive of the tools is deactivated and a work position in which the rotary drive of the tools is 15 activated.

According to one particular aspect of According the invention, said gripping means comprise a gripping handle located on the side of the first end of said body and a holding handle located between the first and second ends of said body.

According to one particular aspect of the invention, said body has a hinge enabling the machine to be folded.

According to one particular aspect of the invention, the motor-driven machine is of the walk-behind type, especially a cultivator.

### BRIEF DESCRIPTION OF THE FIGURES

Further purposes, characteristics and advantages of the invention will become clearer upon reading the following description, given by way of a simple illustrative and non-limiting example, in connection with the figures, among which:

FIG. 1 is a perspective view of a motor-driven machine according to one particular embodiment of the invention, in a position of use;

FIG. 2 is a perspective view of the motor-driven machine of FIG. 1, in a storage position, with the body of the machine folded up;

FIG. 3 is a detail view of the tool head of the motor-driven machine according to the embodiment of FIG. 1, the head carrying a first type of tool;

FIG. 4 is another detail view of the tool head of the motor-driven machine according to the embodiment of FIG. 1;

FIG. 5 is a top view of the tool head of the motor-driven machine according to the embodiment of FIG. 1;

FIG. 6 is a side view of the tool head of the motor-driven machine according to the embodiment of FIG. 1;

FIG. 7 is an exploded perspective view of the tool head of the motor-driven machine according to the embodiment of FIG. 1;

FIG. 8 is a perspective view of a first implementation of the motor and motor reducer assembly on the tool head;

FIG. 9 is a perspective view of a second implementation of the motor and motor reducer assembly on the tool head;

FIG. 10 is a perspective view of a second type of tool;

FIG. 11 is an exploded perspective view of the second type of tool;

FIG. 12 is an exploded perspective view of the first type of tool that can be mounted to the machine in accordance with the invention;

FIG. 13 is an exploded perspective view of the first type of tool;

FIG. 14 is a perspective view of a third type of tool that can be mounted to the machine in accordance with the invention, and

FIG. 15A to [FIG. 15D] illustrate the implementation of a movable protection bar on the machine.

### DETAILED DESCRIPTION OF EMBODIMENTS OF THE INVENTION

The invention thus provides a motor-driven machine for working the ground or soil, especially, and which is biodiversity-friendly. This machine comprises tools that rotate along counter-rotating directions about distinct parallel axes of rotation, the axes of rotation of the tools extending, when the machine is configured for use, in parallel planes substantially perpendicular to the surface of the earth or soil.

This motor-driven machine may be of the walk-behind type, especially a cultivator, or it may be portable.

The tools of such a machine are therefore arranged vertically or substantially vertically above the ground, and rotate in opposite directions in the manner of a kitchen mixer so as to mix the soil to loosen it, without causing inversion of the soil layers.

The machine thus enables the soil to be decompacted and aerated, without causing the lower layers of soil to rise and without killing micro-organisms such as earthworms.

In other words, the machine of the invention enables only the upper layer of soil to be worked (which may represent 5 to 10 cm, for example) to facilitate its aeration and permeability to irrigation water, while preserving the richness of the soil nutrient layers.

It is furthermore ergonomic and adapted to all types of user.

Several particular embodiments of the invention are now set forth in connection with FIGS. 1 to 15D.

As illustrated in these figures, the motor-driven machine 1 according to the invention comprises:
a body C;
gripping means 2, 7 for gripping the motor-driven machine 1 mounted at a first end of the body C, especially;
a tool head 3 mounted at a second end of the body C, opposite to the first end.

The body C here takes the form of a tubular handle or pole which terminates at the first end in a gripping handle 2 preferably provided with an electric control switch. A holding handle 7 is also mounted to the body C and is centred between the first end and the second end. The handle may be adjustable.

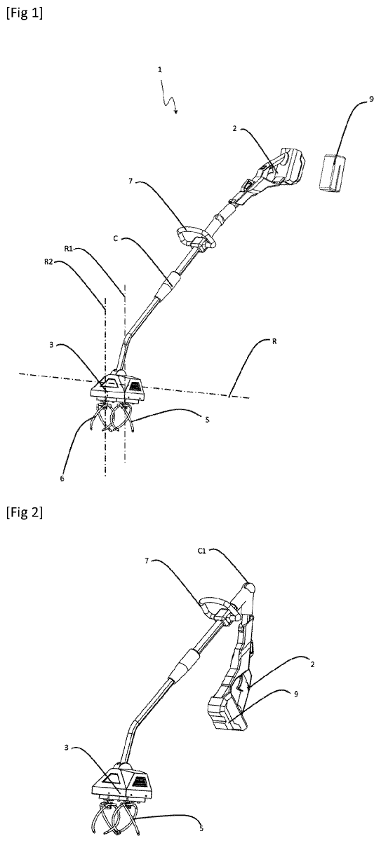

As illustrated in FIG. 2, the body C of the device is foldable at a hinge Cl so as to minimise overall size of the motor-driven machine when not in use.

In another embodiment, the device is in two parts.

In this embodiment, and as also illustrated in FIG. 2, the motor-driven machine is powered by a power source in the form of a rechargeable electric battery 9 located at the first end.

The tool head 3 carries at least two earth or soil working tools 5, 6 which are driven by drive means (motor) which serve to rotate 4 both tools. Each of both tools comprises claws with a round cross-section and curved shape (spiroidal or helical), that is with a convex curvature. As illustrated by the arrows in FIG. 1, these tools 5, 6 are rotatably movable in opposite directions about separate parallel axes of rotation R1, R2. Furthermore, the axes of rotation of the tools are at an angle β of between 45° and 90° to the ground when configured for use, so that the tools penetrate the earth or ground substantially vertically.

The left tool rotates anti-clockwise and the right tool rotates clockwise.

Due to the opposite reactions of the right tool on the left one, and vice versa, stability of the motor-driven machine is optimised.

The counter-rotating tools thus penetrate the ground along a substantially vertical direction. The tools, which are curved wires, provide a natural forward feed effect that makes the machine easier to use. This force, which tends to make the tools penetrate the soil, makes the machine easy to handle and ergonomic (limiting MSD).

According to the embodiments of the invention, this angle is not adjustable and the tool head is fixedly mounted to the body C of the motor-driven machine. It is thus possible to provide different models of motor-driven machines in accordance with the invention having different fixed tool penetration angles β in the soil or earth.

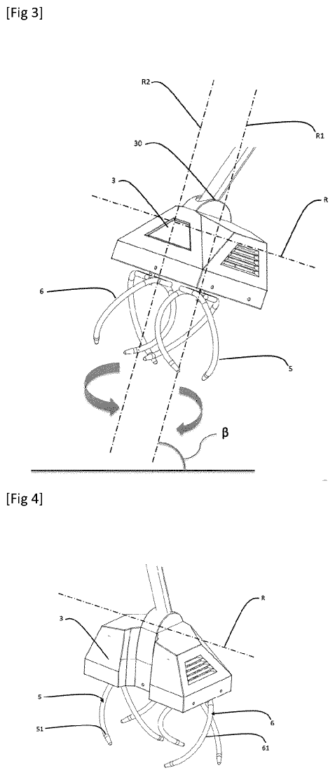

According to an embodiment described below, the tool head is hingedly mounted to the body C of the motor-driven machine so that this angle β can be adjusted by the user between 45° and 90°. In the embodiment illustrated especially in FIGS. 1 to 4, the tool head 3 is hingedly mounted to the body C, by means of orientation means 30, so that the user can orientate the tools 5, 6 in a plurality of earth or soil work positions. The tool head can thus be indexed. It should be noted that the axis of rotation R of the tool head 3, illustrated in FIG. 3, is orthogonal to each of the axes of rotation R1, R2 of the tools 5, 6.

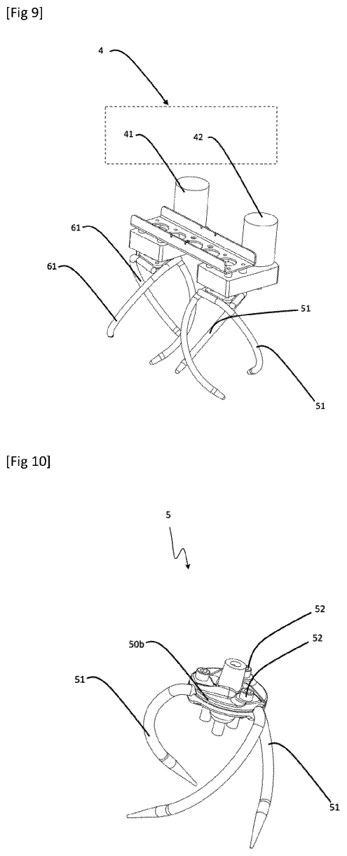

In this embodiment, and as more particularly illustrated in FIG. 7, these means for orientating the tool head comprise a hollow cylinder 31 carried by the end of the body C and arranged in a complementary shaped through housing 32 formed on the upper part of the tool head.

These orientation means also comprise means for holding the cylinder 31 on the tool head which implements a female rod 33 passing through the cylinder 31 and the housing 32 on a first side along the axis of rotation R, the female rod 33 cooperating with a male rod 34 passing through the cylinder 31 and the housing 32 on a second side along the axis of rotation R. A toothed wheel 35 is arranged between this male rod 34 and the housing 32, and the female rod 33 carries a spring. This toothed wheel 35 allows fine adjustment of the angle of orientation of the tool head and therefore of the tools in relation to the ground or earth in the position of use.

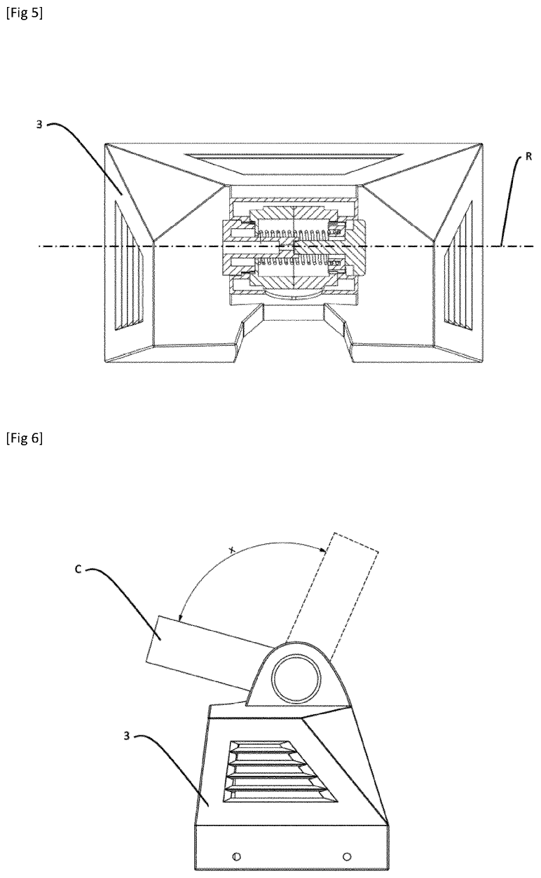

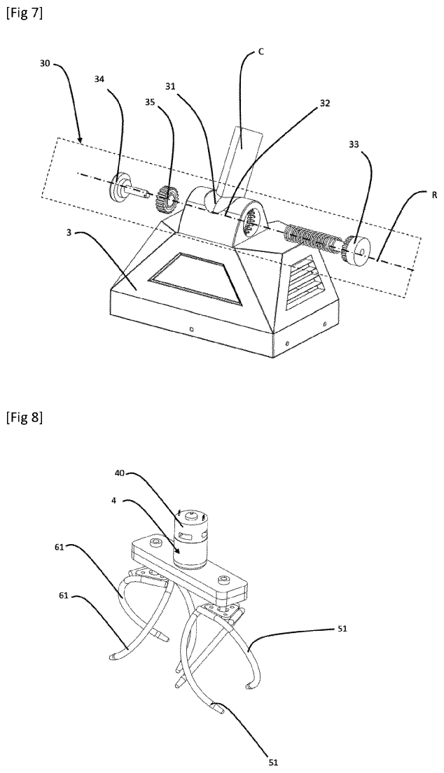

In this way, as illustrated in FIG. 6, the tool head can pivot relative to the body pole C about the axis of rotation R. The head 3 is thus firmly mounted to the body C and can be orientated by the user in several work positions.

In the embodiment set forth herein, the motor-driven machine further has means for locking/unlocking the orientation means 30.

These locking/unlocking means may, for example, take the form of a locking/unlocking handle or a pin. As described in detail, the tools are rotatably driven by rotary drive means 4 which are located here on the tool head and which are powered by the electric battery located at the other end of the body forming pole C.

In this way, the motor drive is located at the end of the pole on the tool side.

According to the embodiment illustrated in FIG. 8, the drive means may comprise a single electric motor reducer 40 which rotatably drives the two tools 5, 6. In this case, this single electric motor reducer has two rotary output shafts, namely one for each of the tools.

According to the embodiment illustrated in FIG. 9, the drive means comprise two electric motor reducers 41, 42, each of which rotatably drives one of said tools. In this case, each of the electric motor reducers has a rotary output shaft.

By means of this or these electric motor reducer (s), the tools rotate at a speed of between 25 revolutions/minute and 75 revolutions/minute.

Preferably, the tools rotate at a speed of about 50 revolutions/minute.

This speed ensures smooth, gradual penetration of the tools, in this case curved (spiroidal or helical) claws, into the earth or soil.

Unlike prior art, where the cutters on the machines rotate at about 140 revolutions/minute, the low rotational speed of the tools on the machine in accordance with the invention means that the upper layer of soil can be smoothly agitated and decompacted. This low speed of rotation further reduces shocks and jolts and makes the motor-driven machine much easier to handle for the user.

In addition, the tools rotate in opposite directions, which tends to propel the machine forward over the ground. Because these tools work vertically or substantially vertically, they do not bring up the lower layers of soil or do so only to a limited extent and do not damage earthworms.

One first implementation of the means for connecting the tools to the tool head is set forth, especially with the help of FIGS. 10 and 11.

As illustrated in these figures, each tool 5, 6 of this embodiment is mounted to a first stage 50a, itself removably mounted to a second stage 50b integral with a rotary output shaft of the motor reducer.

It should be noted that according to different possible implementations, the first stage and the second stage may be of circular, triangular, oval or polygonal shape, for example. Here, the first and second stages are or circular shape.

In FIGS. 10 and 11, each of the tools 5, 6 has a plurality of claws 51, 61 clamped between the first stage 50a and the second stage 50b.

Here, the claws are attached to the stages by means of three screws 52 which attach the first stage 50a and the second stage 50b together.

In this way, the tools are quickly interchangeable.

As illustrated, the claws 51, 61 are curved in the direction of rotation of the tool 5, 6.

These claws, here helical or spiroidal-shaped and round in cross-section, are made of steel wire with a diameter that can be between 6 and 12 mm depending on the power and size of the motor-driven machine. These steel wires, which make up the claws, are bent and/or forged in such a way as to obtain the substantially helical or spiroidal shape illustrated.

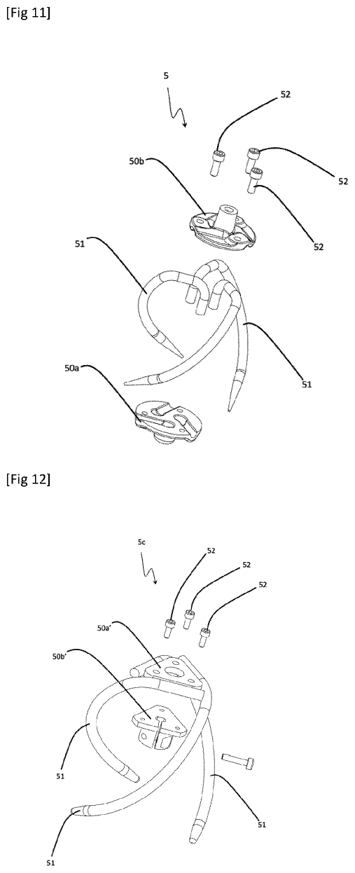

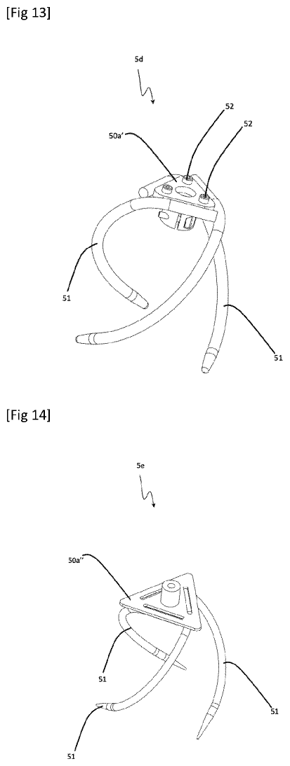

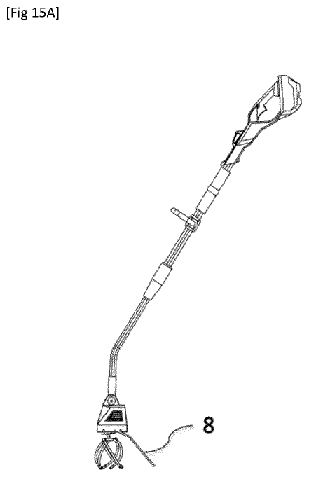

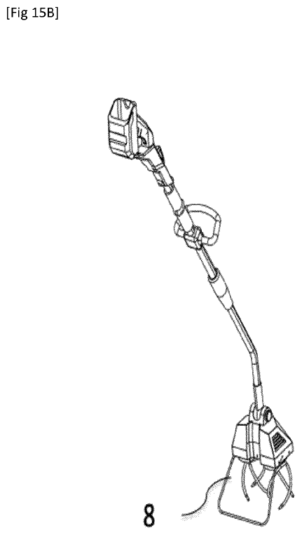

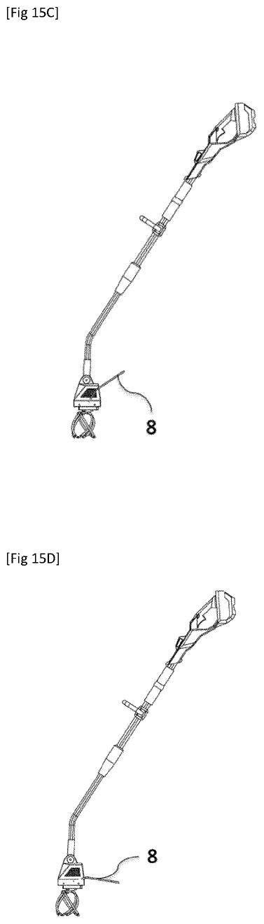

The free end of each claw can be shaped as a point at a sharp angle (FIGS. 10 and 11, as well as FIG. 14), or with a rounded end (FIGS. 12 and 13), according to the embodiment illustrated, in order to ensure proper penetration of the ground.

According to one alternative, this point can have different portions with different bending angles in order to limit wear on the tool during use.

Here, each claw has a first end portion passing through the stage 50a, from which extends a second portion extending at right angles to the first portion and located between the stages 50a and 50b once these have been secured, second portion from which extends a curved claw with a helical or spiroidal shape.

The tools can have more than three or just one or two claws.

The two juxtaposed tools of the machine are therefore formed by a pair of rotatably driven helical or spiroidal claws, each claw rotating in the opposite direction to the other claw (that is the two curved claws rotate in a counter-rotating manner).

Each pair of curved claws substantially extends in the longitudinal direction of the body of the equipment and at some ground penetration angle. As previously described in connection with one particular embodiment, the angle of penetration of the helical or spiroidal claws into the ground can be adjusted by the user according to the nature of the ground and the ergonomics desired by the user.

FIGS. 12 and 13 show different mounting of the claws, which here are attached to the peripheral edge of both stages 50a′ and 50b′, which are of complementary triangular shape, both stages being connected via three screws 52.

Additionally, as illustrated in FIG. 14, a single stage 50a″ could be provided for connection to the motor reducer, under which three claws 51 are attached.

It is understood that the motor-driven machine in accordance with the invention comprises a tool head 3 capable of carrying two or more tools.

Other means for transmitting the mechanical movement of the tool may be implemented without departing from the scope of the invention.

An electronic torque limiter can be implemented on the machine so as to cut power supply to the tools when a peak in intensity is detected, this peak occurring when a tool is jammed in a stone or root in the ground, A mechanical torque limiter can alternatively be implemented to cut off power supply depending on the value of the continuously measured supply current.

The solution of the invention can be implemented on a walk-behind machine.

Such a machine is adapted for working tools with different geometries (and different end finishing states: pointed or rounded, etc.).

The quick disconnect feature set out above means that the machine can be used with different accessories (rounded or double-edged weeder blades, weeding brush, etc.).

An orientation pivot can be provided at the top of the pole for ergonomic adjustment. The pole can be telescopic.

As illustrated in FIGS. 15A to 15D, the machine can be equipped with a movable protection bar 8 that is pivotably mounted on the tool head 3. The position of the bar controls the power supply to the tools.

When the machine is in a storage position (FIG. 15A and FIG. 15B), the protection bar 8 is in the low position to place the equipment stably on the ground. In this case, the tool supply circuit is open and it is impossible to rotate the tools. In a work position (FIG. 15D), the bar is horizontal, so that the operator's feet are away from the tools. The tool supply circuit is closed and the tools can be rotatably driven.

The high and low positions (FIG. 15A, FIG. 15B and FIG. 15C) are safety positions where the tools are not powered and therefore cannot rotate. If the bar is struck by a leg or foot, the bar moves up or down according to the angle of contact and instantly stops tool rotation.

1. A motor-driven machine for working the ground or soil especially comprising:
a grip for gripping said machine located at a first end of said machine;
a tool head mounted at a second end of said machine, opposite to the first end, said head carrying at least two tools;
a body connecting the first and second ends; and
a rotatable drive element which rotatably drives said tools along counter-rotating directions about distinct parallel axes of rotation, the axes of rotation of the tools extending, when the machine is configured for use, in parallel planes substantially perpendicular to a surface of the earth or ground,
said at least two tools each comprising claws with a round cross-section and curved shape, and
said tool head carrying a safety bar movable between at least one safety position in which the rotatable drive element is deactivated and a work position in which the rotatable drive element is activated.

2. The motor-driven machine according to claim 1, wherein the tool head is hingedly mounted to the body by an orientation element, so as to be able to orientate said tools in a plurality of positions for working the earth or the ground, an axis of rotation of the tool head being orthogonal to each of the axes of rotation of the tools.

3. The motor-driven machine according to claim 1, wherein the rotatable drive element is located at the second end of the machine.

4. The motor-driven machine according to claim 3, wherein the rotatable drive element comprises at least two electric motor reducers, each connected to rotatably drive one of said at least two tools.

5. The motor-driven machine according to claim 3, wherein the rotatable drive element comprises a single electric motor reducer connected to rotatably drive said at least two tools.

6. The motor-driven machine according to claim 1, wherein the rotatable drive element comprises at least one motor transducer and each tool comprises one or more elements for working the ground or soil integral with a first stage reversibly mounted to a second stage connected to the at least one motor reducer.

7. The motor-driven machine according to claim 1, wherein the rotatable drive element is configured to rotate the at least two tools at a speed of between 25 revolutions/minute and 75 revolutions/minute.

8. The motor-driven machine according to claim 1, wherein the machine is powered by a rechargeable electric battery.

9. (canceled)

10. The motor-driven machine according to claim 1, wherein the grip comprises a gripping handle located at the first end of said body and a holding handle located between the first and second ends of said body.

11. The motor-driven machine according to claim 1, wherein said body has a hinge enabling the machine to be folded.

12. The motor-driven machine according to claim 1, wherein the machine is of a walk-behind type of machine.
